(19) United States
(12) Patent Application Publication
(10) Pub. No.: US 2018/0247271 A1
(43) Pub. Date: Aug. 30, 2018

(54) VALUE OF CONTENT RELEVANCE THROUGH SEARCH ENGINE OPTIMIZATION

(71) Applicant: Linkedln Corporation, Sunnyvale, CA (US)

(72) Inventors: Huan Van Hoang, San Jose, CA (US); Chi-Yi Kuan, Fremont, CA (US); Yongzheng Zhang, San Jose, CA (US); Quan Wang, Pittsburgh, PA (US)

(21) Appl. No.: 15/444,414

(22) Filed: Feb. 28, 2017

(51) Int. Cl. G06Q 10/10; G06Q 50/00; G06F 17/30

(52) U.S. Cl. CPC G06Q 10/1053; G06F 17/30864; G06Q 50/01

(57) ABSTRACT

A system is configured to determine the impact on ranking of one or more job postings in view of the relevancy of the terms used by the one or more job postings. Using predetermined keywords, the system obtains search results from a variety of sources, and then vectorizes the contents of those search results. Vectorizing may include removing syntactic language and converting the search results to a plain text format. The system further determines relevant terms from the vectorized search results for each of the predetermined keywords, and then computes relevancy values for each of the predetermined keywords using the relevant terms. Through regression modeling, the system determines regression coefficients given the relevancy values and the sources of the search results. The regression coefficients indicate the impact that relevancy of the terms used in the job postings has on the ranking of the job postings.

### TECHNICAL FIELD

The subject matter disclosed herein generally relates to search engine optimization of an associated group of keywords and, in particular, to determining the expected change in the ranking of the associated group of keywords by the search engine in response to changes in the relevancy of the associated group of keywords.

### BACKGROUND

Search Engine Optimization (SEO) is the process of driving traffic to a website using organic search results obtained from one or more search engines. The operator of a website generally prefers SEO because a search engine is often the primary method by which a user of the Internet learns about a website and the information provided by the website. As websites are often ranked by a search engine, having a higher ranking can generate more visits to the website than using other tools or mechanisms for driving traffic to the website (e.g., social networking services, word of mouth, web advertisements, etc.). As generally understood, SEO is performed by refining and crafting one or more webpages of the website to closer align with search engine users' search intentions and information needs.

One factor in performing SEO on a website is designing the website with content relevance in mind. Content relevance generally means that, when creating the content, the core message of the website should be relevant to the keywords that the search engine user used in crafting his or her search. Generally, the content should be relevant and/or related to the meaning of the keywords used by the user, and should not deviate too topically far from the meaning of those keywords. Additionally, the content should provide sufficient breadth and depth about the keyword. The content should develop the keyword with surrounding concepts and phrases instead of repeating the keyword unnaturally.

In the context of search engine optimization, there are a number of challenges in designing a website or web page to be optimal and/or relevant to a given search engine. In particular, it can be difficult to infer how a search engine rates the relevancy of the website's content to a given keyword, whether a website has provided relevant and/or sufficient content for a given keyword, and how much benefit content optimization can bring to the website prior to crafting the content.

### BRIEF DESCRIPTION OF THE DRAWINGS

Some embodiments are illustrated by way of example and not limitation in the figures of the accompanying drawings.

FIG. 1 is a block diagram illustrating a networked system, according to some example embodiments, including a social networking server.

FIG. 2 illustrates the social networking server of FIG. 1, according to an example embodiment.

FIGS. 3A-3B illustrate a method, in accordance with an example embodiment, for determining coefficients that signify the importance of ranking position to relevance for a given set of keywords.

FIGS. 4A-4B illustrate a method, in accordance with an example embodiment, for generating a first matrix of job titles and associated relevant terms, where the associated relevant terms were obtained from a first source.

FIGS. 5A-5B illustrate a method, in accordance with an example embodiment, for generating a second matrix of job titles and associated relevant terms, where the associated relevant terms were obtained from a second source.

FIG. 6 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example methods and systems are directed to performing search engine optimization on one or more job postings provided by, or accessible from, a social networking service and determining whether the ranking by a search engine of such job postings would be affected based on changes to the content of such job postings. In some circumstances, the job postings maintained by the social networking service may be searchable by a publicly accessible search engine and/or searchable by a search engine implemented by the social networking service. When a user uses the publicly accessible search engine to conduct a search using one or more keywords, one or more job postings provided by the social networking service may be presented as search results by the publicly accessible search engine. As the social networking service may have a large candidate employee pool (represented as member profiles), an employer may use the social networking service to establish one or more job postings to attract various candidate employees. To attract the more desirable candidate employees, an employer may desire that its job postings appear within the top ranked search results. A candidate employee (e.g., a member of the social networking service) more use various keywords in an attempt to search for and/or discover the various job postings provided by the social networking service.

However, it is likely that the words and phrases appearing in a given job posting are not identical to the keywords used by the user. Instead, such words and phrases may be related. Thus, job postings that use similar and related keywords are likely to appear as “top” search results (e.g., one of the first ten search results), whereas job postings using less similar words and phrases are likely to appear as secondary or tertiary search results.

The systems and methods include obtaining an initial ranked set of web pages from the given search engine given an initial set of keywords used by one or more job postings, and then using this initial ranking to determine a potential corresponding ranking to the one or more job postings using the given search engine. In this manner, the one or more job postings can be revised and/or edited to be more aligned with the relevancy of the initial set of keywords from the perspective of the given search engine.

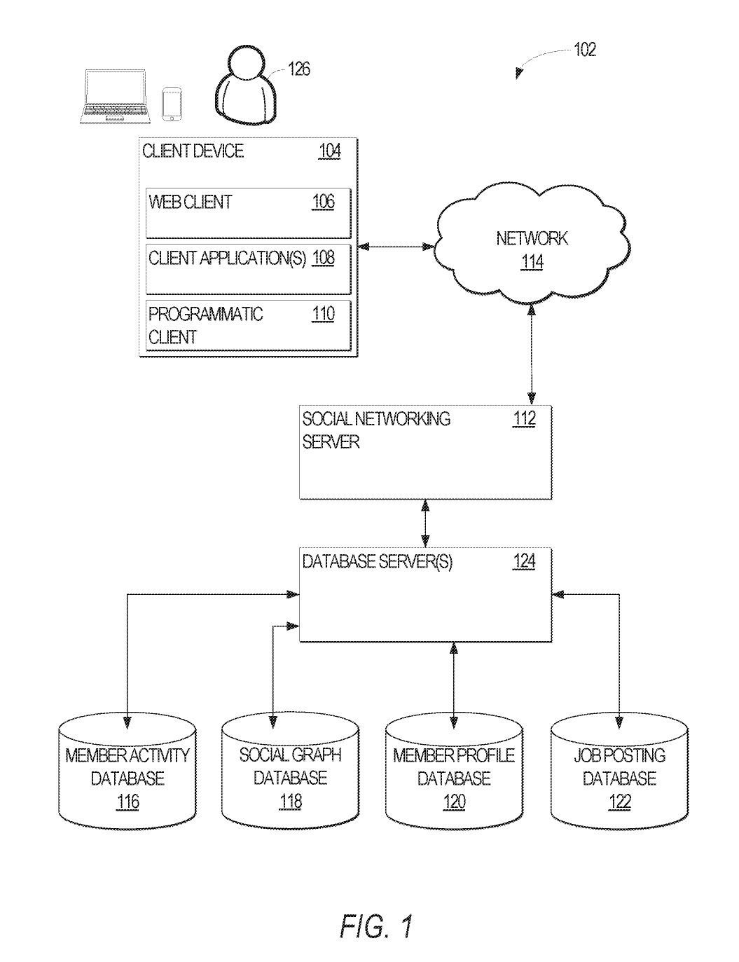

With reference to FIG. 1, an example embodiment of a high-level client-server-based network architecture 102 is shown. A social networking server 112 provides server-side functionality via a network 114 (e.g., the Internet or wide area network (WAN)) to one or more client devices 104. FIG. 1 illustrates, for example, a web client 106 (e.g., a browser, such as the Internet Explorer® browser developed by Microsoft® Corporation of Redmond, Wash. State), client application(s) 108, and a programmatic client 110 executing on client device 104. The social networking server 112 is further communicatively coupled with one or more database servers 122 that provide access to one or more databases 116-122.

The client device 104 may comprise, but is not limited to, a mobile phone, desktop computer, laptop, portable digital assistant (PDA), smart phone, tablet, ultra book, netbook, laptop, multi-processor system, microprocessor-based or programmable consumer electronic, or any other communication device that a user 126 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth. The client device 104 may be a device of a user 126 that is used to perform one or more searches for user profiles accessible to, or maintained by, the social networking server 112.

In one embodiment, the social networking server 112 is a network-based appliance that responds to initialization requests or search queries from the client device 104. One or more users 126 may be a person, a machine, or other means of interacting with the client device 104. In various embodiments, the user 126 is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 104 may include one or more applications (also referred to as “apps”) such as, but not limited to, a web browser, messaging application, electronic mail (email) application, a social networking access client, and the like. In some embodiments, if the social networking access client is included in the client device 104, then this application is configured to locally provide the user interface and at least some of the functionalities with the application configured to communicate with the social networking server 112, on an as needed basis, for data and/or processing capabilities not locally available (e.g., access to a member profile, to authenticate a user 126, to identify or locate other connected members, etc.). Conversely if the social networking access client is not included in the client device 104, the client device 104 may use its web browser to access the initialization and/or search functionalities of the social networking server 112.

One or more users 126 may be a person, a machine, or other means of interacting with the client device 104. In example embodiments, the user 126 is not part of the network architecture 102, but may interact with the network architecture 102 via the client device 104 or other means. For instance, the user 126 provides input (e.g., touch screen input or alphanumeric input) to the client device 104 and the input is communicated to the client-server-based network architecture 102 via the network 114. In this instance, the social networking server 112, in response to receiving the input from the user 126, communicates information to the client device 104 via the network 114 to be presented to the user 126. In this way, the user 126 can interact with the social networking server 112 using the client device 104.

Further, while the client-server-based network architecture 102 shown in FIG. 1 employs a client-server architecture, the present subject matter is of course not limited to such an architecture, and could equally well find application in a distributed, or peer-to-peer, architecture system, for example.

In addition to the client device 104, the social networking server 112 communicates with other one or more database server(s) 124 and/or database(s) 116-122. In one embodiment, the social networking server 112 is communicatively coupled to a member activity database 116, a social graph database 118, a member profile database 120, and a job posting database 122. The databases 116-122 may be implemented as one or more types of databases including, but not limited to, a hierarchical database, a relational database, an object-oriented database, one or more flat files, or combinations thereof.

The member profile database 120 stores member profile information about members who have registered with the social networking server 112. With regard to the member profile database 120, the member may include an individual person or an organization, such as a company, a corporation, a nonprofit organization, an educational institution, or other such organizations.

Consistent with some embodiments, when a person initially registers to become a member of the social networking service provided by the social networking server 112, the person is prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the member profile database 120. Similarly, when a representative of an organization initially registers the organization with the social networking service provided by the social networking server 112, the representative may be prompted to provide certain information about the organization. This information may be stored, for example, in the member profile database 120. With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

A member profile may also include information identifying one or more skills that a corresponding has identified as possessing. For example, the member may identify that he or she possesses computer programming skills (e.g., “Computer Programming,” “Debugging,” “C++,” etc.), writing skills (e.g., “Writing,” “Drafting,” etc.), legal skills (e.g., “Contract drafting,” “Document review,” “Litigation,” etc.) and other such skills and/or combination of skills. In one embodiment, the member provides information to the social network service via a graphical user interface (e.g., a webpage), which then updates the member's member profile with the provided skills. Additionally, and/or alternatively, the social networking service may provide a list and/or selectable skills that the member may identify as possessing. In this manner, a member profile includes skills that the member has identified as possessing.

The member profile data may further include a description or summary of the type of tasks and/or jobs that the member has performed during his or her career and/or associate them with one or more organizations. For example, the member may provide a description of the type of work that he or she has performed while employed at a given employer. Similarly, the member may provide a description of the type of courses and/or activities that he or she engaged in while attending a given educational institution (e.g., a university). Regardless of the organization type (e.g., educational, government, private company, non-profit, etc.), the social networking service provides a graphical user interface (e.g., a webpage) that allows the member to provide information about his or her duties and/or activities while attending or employed at a given organization. Thus, the member profile may be leveraged as a substitute résumé for the corresponding member.

Members of the social networking service may establish connections with one or more members and/or organizations of the social networking service. The connections may be defined as a social graph, where the member and/or organization is represented by a vertex in the social graph and the edges identify connections between vertices. In this regard, the edges may be bilateral (e.g., two members and/or organizations have agreed to form a connection), unilateral (e.g., one member has agreed to form a connection with another member), or combinations thereof. In this manner, members are said to be first-degree connections where a single edge connects the vertices representing the members; otherwise, members are said to be “nth”-degree connections where “n” is defined as the number of edges separating two vertices. As an example, two members are said to be “2nd-degree” connections where each member shares a connection in common with the other member, but the members are not directly connected to one another. In one embodiment, the social graph maintained by the social networking server 112 is stored in the social graph database 118.

Although the foregoing discussion refers to “social graph” in the singular, one of ordinary skill in the art will recognize that the social graph database 118 may be configured to store multiple social graphs. For example, and without limitation, the social networking server 112 may maintain multiple social graphs, where each social graph corresponds to various geographic regions, industries, members, or combinations thereof.

As members interact with the social networking service provided by the social networking server 112, the social networking server 112 is configured to monitor these interactions. Examples of interactions include, but are not limited to, commenting on content posted by other members, viewing member profiles, editing or viewing a member's own profile, sharing content outside of the social networking service (e.g., an article provided by an entity other than the social networking server 112), updating a current status, posting content for other members to view and/or comment on, and other such interactions. In one embodiment, these interactions are stored in a member activity database 116, which associates interactions made by a member with his or her member profile stored in the member profile database 120.

The social networking service may further include a job posting database 122 that includes data related to one or more job postings provided by and/or accessible from the social networking service. In one embodiment, a job posting includes various job fields describing the job associated with the job posting. One or more of these job fields may be publicly viewable job fields and one or more of these job fields may be private job fields that are not viewable by members of the social networking service. Publicly viewable job fields include, but are not limited to, a job title field that includes information about the job title, a job description field that includes information describing the job, an employer field that includes information about the employer for the job, a job qualification field that includes information about the qualifications a job candidate should possess when applying to the job.

Private job fields include, but are not limited to, a job posting identifier field that includes a unique identifier that identifies the job posting, a candidate skill field that includes information about the skills that a job candidate should possess, a job poster field that includes information about the entity that created and/or posted the job posting, and other such fields and/or combination of fields. In the context of the job skill field, the job skill field may be populated with one or more standardized names of skills selected from one or more sets of standardized skills that the social networking service maintains in order to more readily identify potential candidates from among members of the social networking service.

Furthermore, one or more of the job fields associated with the job posting may be indexed and/or searchable by one or more search engines. For example, the publicly viewable job fields may be indexed and/or searchable by the one or more search engines. Thus, in response to a search query submitted to a given search engine, the user of the search engine, who may or may not be a member of the social networking service, may be presented with one or more of the job postings stored in the job posting database 122.

In one embodiment, the social networking server 112 communicates with the various databases 116-122 through one or more database server(s) 124. In this regard, the database server(s) 124 provide one or more interfaces and/or services for providing content to, modifying content in, removing content from, or otherwise interacting with, the databases 116-122. For example, and without limitation, such interfaces and/or services may include one or more Application Programming Interfaces (APIs), one or more services provided via a Service-Oriented Architecture (SOA), one or more services provided via a REST-Oriented Architecture (ROA), or combinations thereof. In an alternative embodiment, the social networking server 112 communicates with the databases 116-122 and includes a database client, engine, and/or module, for providing data to, modifying data stored within, and/or retrieving data from, the one or more databases 116-122.

While the database server(s) 124 is illustrated as a single block, one of ordinary skill in the art will recognize that the database server(s) 124 may include one or more such servers. For example, the database server(s) 124 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-124, or combinations thereof. Accordingly, and in one embodiment, the database server(s) 124 implemented by the social networking service are further configured to communicate with the social networking server 112.

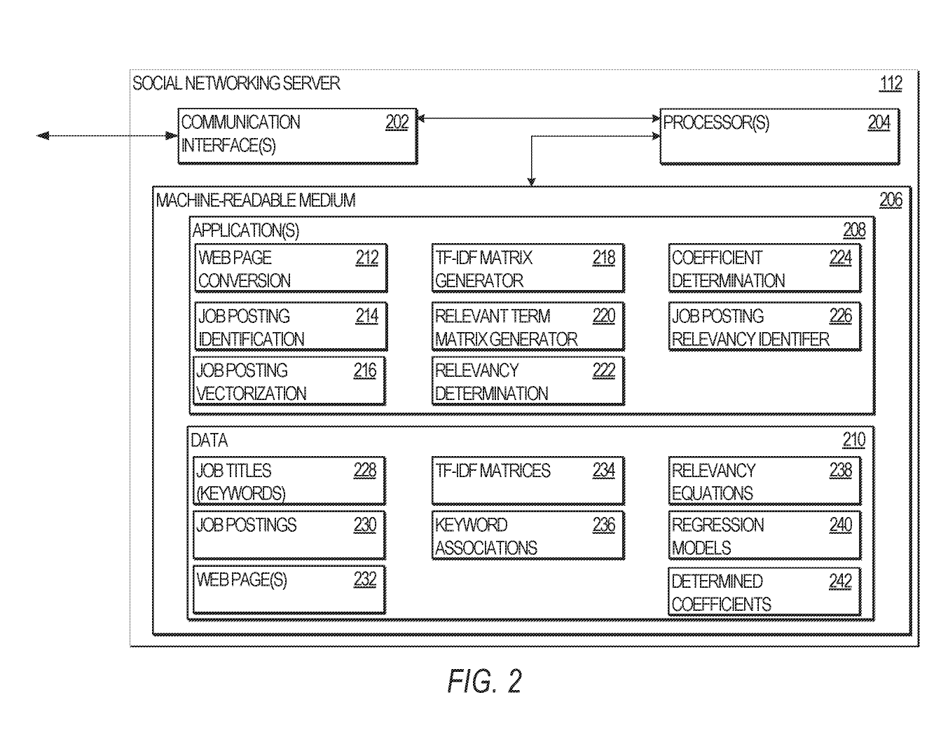

FIG. 2 illustrates the social networking server 112 of FIG. 1, in accordance with an example embodiment. In one embodiment, the social networking server 112 includes one or more processor(s) 204, one or more communication interface(s) 202, and a machine-readable medium 206 that stores computer-executable instructions for one or more applications 208 and data 210 used to support one or more functionalities of the applications 208.

The various functional components of the social networking server 112 may reside on a single device or may be distributed across several computers in various arrangements. The various components of the social networking server 112 may, furthermore, access one or more databases (e.g., databases 116-122 or any of data 210), and each of the various components of the social networking server 112 may be in communication with one another. Further, while the components of FIG. 2 are discussed in the singular sense, it will be appreciated that in other embodiments multiple instances of the components may be employed.

The one or more processors 204 may be any type of commercially available processor, such as processors available from the Intel Corporation, Advanced Micro Devices, Texas Instruments, or other such processors. Further still, the one or more processors 204 may include one or more special-purpose processors, such as a Field-Programmable Gate Array (FPGA) or an Application Specific Integrated Circuit (ASIC). The one or more processors 204 may also include programmable logic or circuitry that is temporarily configured by software to perform certain operations. Thus, once configured by such software, the one or more processors 204 become specific machines (or specific components of a machine) uniquely tailored to perform the configured functions and are no longer general-purpose processors.

The one or more communication interfaces 202 are configured to facilitate communications between the client device 104, the social networking server 112, and one or more of the database server(s) 124 and/or databases 116-122. The one or more communication interfaces 202 may include one or more wired interfaces (e.g., an Ethernet interface, Universal Serial Bus (USB) interface, a Thunderbolt® interface, etc.), one or more wireless interfaces (e.g., an IEEE 802.11b/g/n interface, a Bluetooth® interface, an IEEE 802.16 interface, etc.), or combinations of such wired and wireless interfaces.

The machine-readable medium 206 includes various applications 208 and data 210 for implementing the client device 104. The machine-readable medium 206 includes one or more devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the applications 208 and the data 210. Accordingly, the machine-readable medium 206 may be implemented as a single storage apparatus or device, or, alternatively and/or additionally, as “cloud-based” storage systems or storage networks that include multiple storage apparatus or devices. As shown in FIG. 2, the machine-readable medium 206 excludes signals per se.

In one embodiment, the applications 208 are written in a computer-programming and/or scripting language. Examples of such languages include, but are not limited to, C, C++, C#, Java, JavaScript, Perl, Python, or any other computer programming and/or scripting language now known or later developed.

With reference to FIG. 2, the applications 208 of the social networking server 112 are designed to determine the relevancy of one or more keywords used by the job postings stored in the job posting database 122 and to determine the potential change in the ranking of a given job posting depending on the changes to the relevancy associated with the keywords of the corresponding job posting. To perform these and other operations in furtherance of these results, the application 208 include, but are not limited to, a web page conversion module 212, a job posting identification module 214, a job posting vectorization module 216, a TF-IDF matrix generator 218, a relevant term matrix generator 220, a relevancy determination module 222, a coefficient determination module 224, and a job posting relevancy identifier 226. While the social networking server 112 may include alternative and/or additional applications (e.g., a networking application, a printing application, a software-implemented keyboard, etc.), such alternative and/or additional applications are not germane to this disclosure and the discussion of such is hereby omitted for brevity and readability.

The data 210 referenced and used by the applications 208 include various types of data in support of determining the relevancy of various keywords and determining the relative change in the search engine ranking of a given job posting in response to changes associated with the relevancy of the keywords used by the given job posting. In this regard, the data 210 includes, but is not limited to, one or more job titles 228 that can be associated with the job postings of the job posting database 122, one or more job postings 230 retrieved from and/or accessible within the job posting database 122, various web page(s) 232 and their corresponding plain text equivalents, one or more TF-IDF matrices 234, one or more keyword associations 236, which, as discussed below, may be implemented as one or more two-dimensional tables and/or matrices, one or more relevancy equations 238 used to determine the relevancy of the job titles 228, and one or more regression models 240 that yield one or more coefficients used in determining the ranking of the retrieved job postings 230.

In performing the search engine optimization for the various job postings 230 of the social networking service, the social networking server 112 may first obtain one or more web pages associated with various keywords (e.g., job titles 228) that a given search engine has determined are the most relevant search results. In this context, the most relevant search results are considered to be a predetermined number of web pages that are provided in a ranked order by the given search engine. Thus, the most relevant search results may be the first five search results (e.g., the first five web pages), the first 10 search results (e.g. the first ten web pages), and so forth. The social networking server 112 is configured to store the web pages as web page(s) 232.

The keywords communicated to the given search engine may be keywords selected from one or more attributes (e.g., one or more of the publicly viewable job posting fields and/or one or more of the private job posting fields) of the job postings. In one embodiment, the keywords are job titles 228 that can be associated with the job postings (e.g., obtained from a job title field). The job titles 228 may or may not be, in fact, associated with one or more of the job postings. For example, the job titles may include such keywords as “Director of Engineering,” “Computer Programmer,” “Graphic Artist,” “Plumber,” “Locksmith,” and other such job titles. The job titles may be obtained from a database of job titles (not shown) maintained by the social networking server 112. In this regard, the database of job titles may be populated by an administrator of the social networking server 112 and/or by retrieving the job titles from one or more job postings from the job posting database 122.

As the most relevant search results are returned by the given search engine, it would be helpful to know which words and/or phrases are used by the most relevant search results. This is because the most relevant search results may use words and/or phrases that are similar to the provided keywords (e.g., job titles 228) but are not used by the job postings. Thus, knowing which words and/or phrases are used by the most relevant search results could help in better optimizing the job postings for the given search engine.

However, as the web pages may include content other than text content (e.g., one or more images, sounds, videos, scripting content, formatting content, etc.), the social networking server 112 may first convert the obtained search results (e.g., web pages) into plain text representations of such web pages. Accordingly, in one embodiment, the social networking server 112 includes a web page conversion module 212 that converts the obtained web pages from one format, such as the Hypertext Markup Language (HTML), to another format, such as plain text. To do so, the web page conversion module 212 may reference one or more rules (not shown) that instruct the web page conversion module 212 as to the type of content that the plain text representation should include and/or the type of content that should be excluded from the plain text representation. Further still, the web page conversion module rules may specify syntactical content (e.g., the computer programming/scripting language words, phrases, variables, functions, etc.) that should be excluded from the plain text representation. Thus, as the web page conversion module 212 receives a given web page from the web page(s) 232, the web page conversion module 212 produces a plain text output (e.g., the plain text representation) of the given web page. These plain text representations may then be stored as the web page(s) 232 rather than the HTML-formatted version of the corresponding web pages.

In creating the plain text representations of the obtained web page(s) 232, it should be understood that each job title of the job titles 228 is associated with a corresponding set of plain text representations. Thus, there may be a maximum of M×N total number of plain text representations, where A is the number of job titles 228, and N is the number of webpages retrieved for each of the job titles. Of course, in some instances, there may be fewer webpages associated with a given job title, such as where the given search engine provides a number of web pages less than the predetermined number of web pages defined as the most relevant search results.

Having created the plain text representations of the web pages, the social networking server 112 then generates one or more TF-IDF matrices 234 via the TF-IDF matrix generator 218. As known to one of ordinary skill in the art, TF-IDF is a numerical statistic that is intended to reflect how important a word is to a document in a collection or corpus. The algorithms and/or logic used in the calculation of a TF-IDF matrix are known to those of ordinary skill in the art, and the TF-IDF matrix generator 218 may be a computer program, script, and/or dedicated circuit that implements these algorithms and/or logic.

In one embodiment, the TF-IDF matrix generator 218 uses a set of the plain text representations associated with a given keyword as a corpus (or set of documents) used in the TF-IDF calculation. In particular, the TF-IDF matrix generator 218 may use one or more n-grams selected from the given set of plain text representations and generate the TF-IDF matrix for the plain text representations associated with the given keyword. As known to one of ordinary skill in the art, a TF-IDF matrix may be implemented as a two-dimensional matrix, where one or more columns each represent the n-grams for the collection of plain text representations, and one or more rows each represent the individual plain text representations. The intersection of each row and column includes a numerical value, and this numerical represents the importance of the given n-gram for the plain text representation. A high score (e.g., a score defined to be above a given threshold value) indicates that the n-gram is particularly important. As the TF-IDF matrices are generated for each of the keywords (e.g., job titles 228), the TF-IDF matrix generator 218 may then store the TF-IDF matrices as the TF-IDF matrices 234.

The relevant term matrix generator 220 is configured to determine relevant n-grams from the TF-IDF matrices 234 for their corresponding keywords (e.g., job titles 228). In this regard, the relevant term matrix generator 220 may compare a predetermined threshold value with one or more of the values from the TF-IDF matrices 234. Where a given value from one or more of the TF-IDF matrices 234 exceeds the predetermined threshold value, the relevant term matrix generator 220 may then associate the n-gram associated with the given value with the corresponding keyword (e.g., job title) associated with the TF-IDF matrix from which the n-gram originates. As an example, suppose that a predetermined threshold value is established at 0.70 and that a given job title, such as “locksmith,” is associated with a TF-IDF matrix selected from the TF-IDF matrices 234. Further suppose that the TF-IDF matrix associated with “locksmith” includes such n-grams as “lock,” “doorknob,” “door,” “garage,” and “window,” where the TF-IDF value associated with each n-gram is, respectively, 0.70, 0.40, 0.32, 0.75, and 0.65.

In this example, the relevant term matrix generator 220 compares each of the TF-IDF values (e.g., 0.70, 0.40, 0.32, etc.) with the predetermined threshold value and, for those TF-IDF values that meet or exceed the threshold value (e.g., 0.70 and 0.75), the relevant term matrix generator 220 determines that those n-grams, namely “lock” and “garage,” are to be associated as relevant terms with “locksmith.” Using this methodology, and in one embodiment, the relevant term matrix generator 220 generates a two-dimensional matrix where each row of the two-dimensional matrix represents a given keyword (e.g., job title) and each column represents an n-gram determined to be relevant. The relevant term matrix generator 220 then stores the relevant word associations (via the two-dimensional matrix) as part of the keyword associations 236. As discussed below, the next steps performed by the social networking server 112 include vectorizing one or more job postings and determining relevant n-grams from the vectorized job postings for the various keywords (e.g., job titles 228).

To determine relevant keywords from one or more of the job postings accessible from the social networking service, the social networking server 112 invokes a job posting identification module 214. In one embodiment, the job posting identification module 214 is configured to identify one or more job postings selected from the job posting database 122. The job posting identification module 214 may identify such job postings by determining whether one or more of the job postings includes one or more of the keywords (e.g., job titles 228) as an attribute value for a corresponding attribute (e.g., a publicly viewable job field and/or a private job field).

In one embodiment, this determination is performed by comparing one or more of the job titles 228 with corresponding attribute values for a job title attribute associated with one or more of the job postings. Determining that a given job posting includes a given job title as an attribute value may include determining that the given job posting includes the entirety of the job title or that a portion of the attribute value includes the job title.

In yet another embodiment, one or more of the job postings are associated with standardized attribute values for one or more attributes, and the job titles 228 correspond with such standardized attribute values. Where standardized attribute values are used, the comparison of the standardized attribute values with one or more of the job titles 228 may be a binary determination (e.g., that the job posting is associated with a standardized attribute value that either “is” or “is not” one or more of the job titles 228). Furthermore, the social networking server 112 may implement variations and/or combinations of the foregoing comparisons and/or determinations without departing from the scope of this disclosure.

Where the job posting identification module 214 determines that a given job posting is associated with one or more job titles 228, the job posting identification module 214 records the given job posting as job posting 230. Thus, the job postings 230 include those job postings that the job posting identification module 214 has determined as being associated with one or more of the job titles 228. Of course, in alternative and/or additional embodiments, the job postings 230 may include those job postings that are associated with one or more predetermined key words, regardless of whether such keywords include job titles, educational institution names, government organization names, geographic location names, and other such attributes that are associated with the job postings accessible from the social networking service.

The job posting vectorization module 216 is configured to vectorize one or more of the job postings 230 to obtain potentially relevant words and/or phrases that may be related to one or more of the job titles 228. In one embodiment, the job posting vectorization module 216 implements the WORD2VEC algorithm, which includes a toolset that indicates a numerical value indicating the word cosine distance between an input word and one or more output words. Although Word2Vec uses a training corpus to determine the word cosine distance between words, such a training corpus can be obtained from the hundreds of thousands of job postings of the job posting database 122. Other training corpuses are also freely available via the Internet and other such online resources.

For each job title of the set of job titles 228, the job posting vectorization module 216 returns a set of words and/or phrases that are a word cosine distance for a given job title using the selected job postings 230 having the given job title as a job posting attribute value. The job posting vectorization module 216 may then cull or eliminate those words and/or phrases having a word cosine distance less than (or equal to) a predetermined word cosine distance value. The result of these operations are another set of words and/or phrases associated with each of the job titles 228, derived from the job postings 230, where each word and/or phrase is presumably related to a given job title. These associations may also be stored as part of the keyword associations 236. Accordingly, after these operations, the keyword associations 236 include two sets of words and/or phrases for each job title selected from the job titles 228: a first set derived from the most relevant search results of a given search engine and a second set derived from job postings of the social networking service associated with a job posting attribute value corresponding to the given job title.

Using the various sets of keyword associations 236, the social networking server 112 then determines the relevance of the keyword associations 236 relative to a second set of search results returned by the given search engine when provided with one or more of the job titles 228. In this regard, the social networking server 112 may define a range of search results that are considered sufficient in this determination. For example, the social networking server 112 may define that the 11th-20th search results are considered sufficient for this determination. As another example, the social networking server 112 may define that the 15^{th}-20th search results are considered sufficient. Notably, in one embodiment, the search results used in this second set of search results do not overlap with the search results from the first set (e.g., the search results considered to be the most relevant search results). As before, the social networking server 112 may invoke the web page conversion module 212 to convert the second set of search results to plain text results (e.g., search results without additional syntactical or markup language), with the TF-IDF matrix generator 218 to generate one or more TF-IDF matrices from the second set of search results, and a relevant term matrix generator 220 to generate a set of related terms from the second set of search results given the corresponding job title selected from the job titles 228.

Having obtained the relevant terms for corresponding job titles 228 from the second set of search results, the social networking server 112 is further configured to determine a plurality of relevancy values for each of the job titles 228 by performing at least two relevancy determinations for each job title: a first relevancy determination using the keyword associations 236 obtained from the most relevant search results and the relevant terms from the second set of search results, and a second relevancy determination using the keyword associations 236 obtained from the job postings 230 and the relevant terms from the second set of search results.

In one embodiment, a relevancy determination module 222 implements one or more algorithms to determine the sets of relevancy values for each of the job titles 228. The relevancy determination module 222 may implement such algorithms as the Jaccard Index, the Euclidean Distance, the Pearson Correlation, Cosine Similarity, or any other such algorithm or combination thereof. The various algorithms and/or equations used by the relevancy determination module 222 may be stored as the relevancy equations 238.

With respect to the Jaccard Index, the relevancy determination module 222 may further determine an Edit Distance to allow for fuzzy matching. Using an Edit Distance with the Jaccard Index algorithm is useful at matching strings (e.g., job titles and associated words and/or phrases) with multiple words. For example, the terms “data scientist” and “data science” are semantically very similar, and this implementation recognizes them as a matched pair of terms.

In determining the Edit Distance, the relevancy determination module 222 is configured to determine the Levenshtein distance. Mathematically, the Levenshtein distance between two words a, b (of length |a| and |b| respectively) is given by Lev_{a,b} (|a|, |b|). The equation for the Levenshtein distance is given by the following formula:

$${Lev}_{a , b} ( i , j ) = \{ \begin{matrix}max ( i , j ) & if min ( i , j ) = 0 , \\ min \{ \begin{matrix}{lev}_{a , b} ( i - 1 , j ) + 1 \\ {lev}_{a , b} ( i , j - 1 ) + 1 \\ {lev}_{a , b} ( i - 1 , j - 1 ) + {I}_{( {a}_{i} \neq {b}_{j} )}\end{matrix} & otherwise\end{matrix} . \\ where \\ {I}_{( {a}_{i} \neq {b}_{j} )} = \{ \begin{matrix}0 & {a}_{i} = {b}_{j} , \\ 1 & {a}_{i} \neq {b}_{j}\end{matrix} .$$

i denotes the index of the current character of a; and,

j denotes the index of the current character of b.

In evaluating this equation, the relevancy determination module 222 may first initialize Lev_{a,b}(i,0)=i and Lev_{a,b}(0,j)=j. The relevancy determination module 222 may then evaluate through i=1, . . . , |a| and j=1, . . . , |b| in loops until i=|a| and j=|b|, where i=|a| and j=|b|, Lev_{a,b}(|a|, |b|) is the distance.

The relevancy determination module 222 uses the Levenshtein distance in the following way. For two input strings, A and B, the relevancy determination module 222 tokenizes them into two sets of words. The string length of A and B are denoted as |A| and |B|, respectively. For any word a in string A, the relevancy determination module 222 computes the ratio of

$$\frac{{Lev}_{a , b}}{max ( \vert a \vert , \vert b \vert )}$$

for all words b in string B. Where any of the ratios is smaller than a predetermined relevancy threshold τ, the relevancy determination module 222 determines that a has a fizzy matched word in B; otherwise, the relevancy determination module 222 finds that a does not have a match. After repeating the above for all words in string A, the relevancy determination module 222 obtains the number of matched words m in A and B. The relevancy determination module 222 then determines the Jaccard Index as follows:

$$J ( A , B ) = \frac{\vert A ⋂ B \vert}{\vert A ⋃ B \vert} = \frac{m}{\vert A \vert + \vert B \vert - m}$$

Where the determined Jaccard Index is bigger than a predetermined Jaccard Index threshold σ, the relevancy determination module 222 determines that the string pair A and B is a matched pair; otherwise, the string pair A and B is determined as not a matched pair.

Using the determined and various relevancy values, the social networking server 112 is further configured to determine the impact of content relevance on ranking (e.g., where a given job posting may appear in a list of search results for a given search engine). In one embodiment, the social networking server 112 determines the impact of content relevance using fixed effect regressions that control web page origination heterogeneity and keywords heterogeneity. Then, the social networking server 112 regresses the ranking on the quantified content relevance. The result of these operations is the value of various coefficients used in these regressions, which can be further used to determine the potential impact in the ranking of a given job posting for a given search engine relative to the change in relevancy for the given job posting.

To perform these determinations, the social networking server is configured with a coefficient determination module 224 that determines various coefficients used in the regression model 240. In one embodiment, the regression models 240 leverage various variables and values including, for example, the relevance scores determined by the relevancy determination module 222, the rank of the various search results (e.g., the ranks of the web page(s) 232) returned by the given search engine, a search engine dummy variable indicating the search engine from which a given search result was obtained, and a keyword dummy variable indicating which keyword is the given keyword being used in the regression model 240. In one embodiment, the regression model 240 is represented by the following equation:

RankPos_{i,j}=b₀+b₁·RelevanceScore_{i,j}+CompanyDummyᵢ+KeywordDummyⱼ+eᵢⱼ

where,
RankPos_{i,j} is the ranking position for a given search result i (e.g., a web page) for a corresponding keyword j (e.g., a job title);
b₀ is one coefficient which may assume any real value;
b₁ is a second coefficient which may assume any real value;
RelevanceScore_{i,j} represents the relevancy value for a given keyword j and corresponding search result i;
CompanyDummyᵢ is a series of dummy variables (e.g., a variable that has a value of a 0 or 1) indicating whether a given search engine provided the search result i;
KeywordDummyⱼ is a series of dummy variables indicating which keyword is the keyword j. In one embodiment, the number of values for the KeywordDummy variable corresponds to the number of keywords 228; and
e_{i,j} is a balancing value automatically determined by the coefficient determination module 224.

In one embodiment, the social networking server 112 implements the coefficient determination module 224 using STATA, which is available from StataCorp LP located in College Station Tex. The coefficient determination module 224 may execute the “areg” command and instruct STATA to perform an Ordinary Least Square Estimation, where the input to the coefficient determination module 224 is a two-dimensional table, where the number of rows in the table correspond to the number of keywords 228, and the two-dimensional table includes four columns labeled “Ranking Position,” which corresponds to the variable RankPos; “Relevance Score,” which corresponds to the variable RelevanceScore; “Company Name,” which corresponds to the variable CompanyDummy; and “Keyword Name,” which corresponds to the KeywordDummy. Using the values corresponding to “Company Name” and “Keyword Name,” the coefficient determination module 224 is configured to transform these values into values for each CompanyDummy and each KeywordDummy. The transformation is done through executing the command “absorb”, which allows converts categorical variables into 0 and 1 dummy variables. For example, where the categorical variable CompanyName takes four values (e.g., ABC, XYZ, ACME, and COMPANY), executing “absorb(CompanyName)” will create four dummy variables, each indicating whether the company name takes the corresponding value. If the CompanyName is ABC, the four company dummy values will be 1,0,0,0. Similarly, where the CompanyName is XYZ, the four company dummy values will be 0,1,0,0.

Having executed the “areg” command using the regression model 240, the coefficient determination module 224 then outputs the main coefficients b₀ and b₁ and a corresponding significance level for each coefficient. The values of the coefficients are stored as the determined coefficients 242. The coefficient determination module 224 also generates an F statistic and an adjusted R-square value. Since the regression model 240 represents one implementation of the ordinary least square (OLS) regression, the F statistics and adjusted R-square are calculated the same way as in the standard OLS models.

The resulting coefficients b₀ and b₁ indicate the potential impact that improving or changing the relevancy of the words and/or phrases used with a corresponding keyword (e.g., job title) on the ranking of those job posting(s) that use the corresponding keyword with regard to a corresponding search engine. These values may be used by one or more modules of the social networking server 112 in determining the expected change in rank of a given job posting depending on the amount of change in the relevancy of the words and phrases used in the given job posting.

For example, in one embodiment, the job posting relevancy identifier 226 is configured to identify those job postings 230 where changes in the words and/or phrases used in a job posting are expected to increase the ranking of the job posting relative to a given search engine. As discussed above, each job posting of the job postings 230 may be associated with a corresponding job title selected from the job titles 228 (e.g., via a two-dimensional table or the like where a job posting identifier is used as the primary key for the corresponding job title). The job posting relevancy identifier 226 is further configured to reference the job postings 230 and identify the corresponding job title selected from the job titles 228 (e.g., by accessing a primary key or other unique identifier to identify the corresponding job title). The job posting relevancy identifier 226 then retrieves the corresponding b₀ and b₁ values associated with the selected job title from the determined coefficients 242. Additionally, and/or alternatively, the b₀ and the b₁ values are global values for all of the job titles 228.

By comparing the retrieved b₀ and b₁ values with a predetermined coefficient threshold (e.g., a value selected between 0 and 1), the job posting relevancy identifier 226 identifies which job postings selected from the job postings 230 would benefit from changes that improve the relevancy of the words and phrases used by the job posting. For example, where the predetermined coefficient threshold is established as 0.3, and b₀ for a given keyword is determined as 0.4, the job posting relevancy identifier 226 identifies those job postings associated with the given keyword as job postings that could be improved through changes to the words and/or phrases used in the job posting. In an alternative embodiment, the predetermined coefficient threshold is compared with b₁. In yet a further embodiment, the social networking server 112 establishes a first coefficient threshold to be compared with b₀ and a second coefficient threshold to be compared with b₁.

In one embodiment, the job posting relevancy identifier 226 suggests words and/or phrases to members associated with corresponding job postings that the job posting relevancy identifier 226 has identified. The words and/or phrases suggested by the job posting relevancy identifier 226 may be words and/or phrases stored as part of the keyword associations 236. In this manner, the job posting relevancy identifier 226 can help members of the social networking service improve the relevancy of their job postings and the likelihood that a search engine determines a higher ranking for a given job posting.

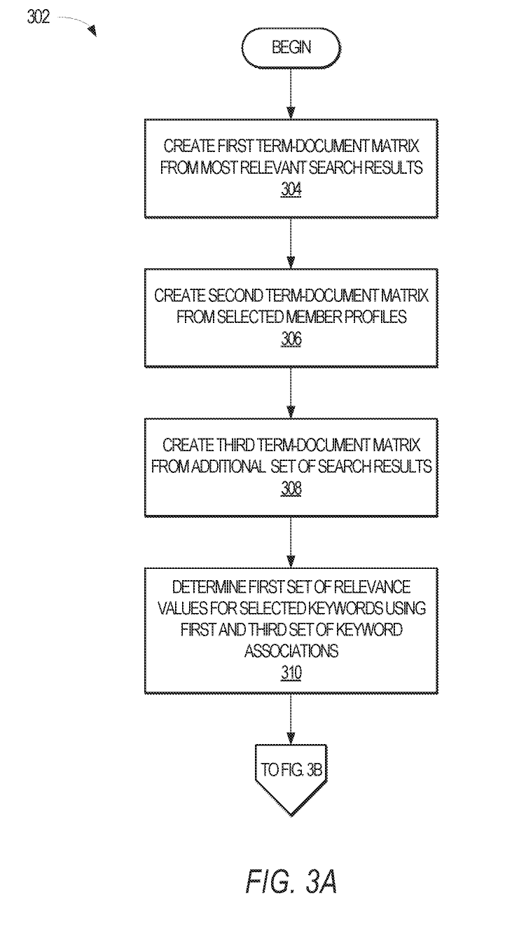

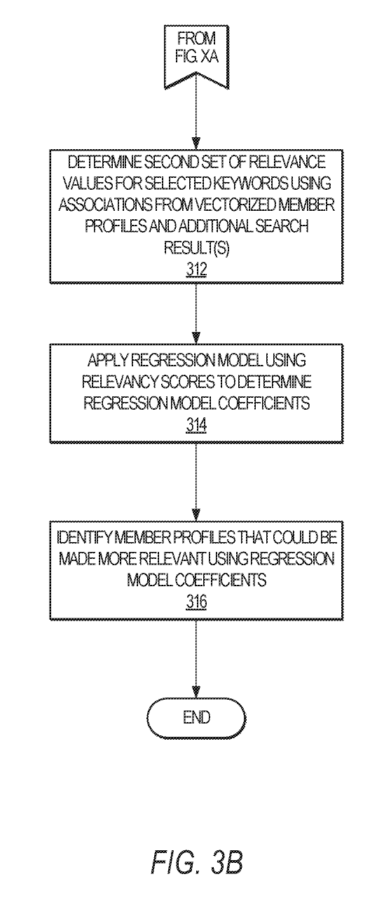

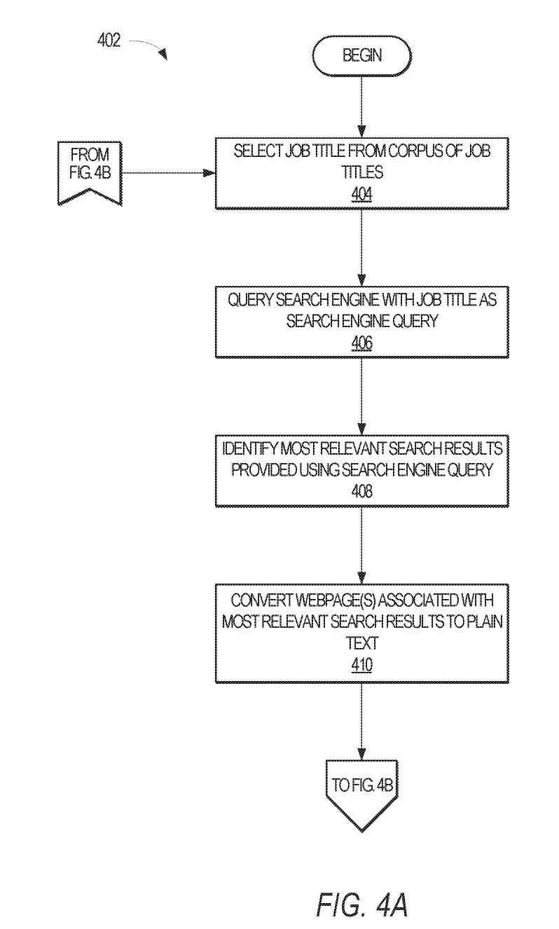

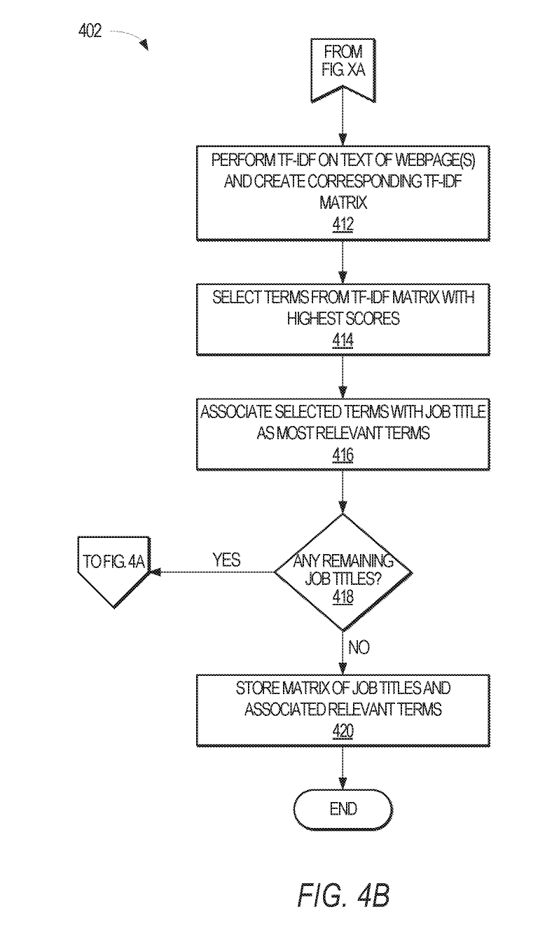

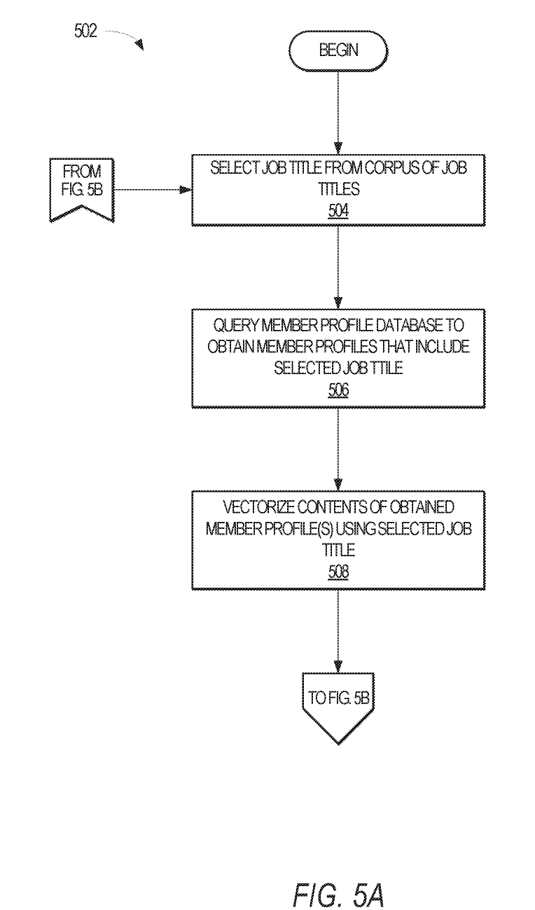

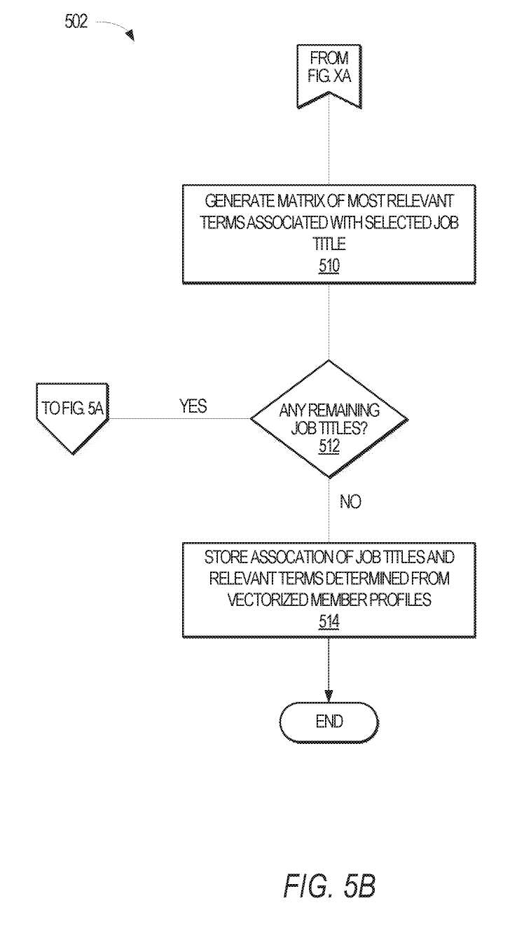

FIGS. 3A-3B illustrate a method 302, in accordance with an example embodiment, for determining coefficients that signify the importance of ranking position to relevance for a given set of keywords. The method 302 may be implemented by one or more of the modules illustrated in FIG. 2 and is discussed by way of reference thereto. The method 302 illustrates one or more operations previously discussed above, and FIGS. 4A-5B further illustrate specific implementations of the operations discussed in FIGS. 3A-3B.

In determining the impact of relevancy on the ranking of one or more job postings 230, the social networking server 112 establishes one or more TF-IDF matrices 234. Accordingly, the first part of the method 302 is to create a first TF-IDF matrix from a set of relevant search results using one or more keywords (e.g., job titles 228) that can be associated with one or more of the job postings 230 (Operation 304). The relevant search results may include search results from one or more different search engines or other providers of search results. The method 302 then includes creating a second TF-IDF matrix from selected job postings of the social networking service provided by the social networking server 112 (Operation 306). Additional details regarding Operations 306-308 are discussed below with reference to FIGS. 4A-4B and FIGS. 5A-5B, respectively.

FIGS. 4A-4B illustrate a method 402, in accordance with an example embodiment, for generating a first matrix of job titles and associated relevant terms, where the associated relevant terms were obtained from a first source of keywords. The method 402 may be implemented by one or more of the modules illustrated in FIG. 2 and is discussed by way of reference thereto. In one embodiment, the method 402 corresponds to Operation 304 illustrated in FIG. 3A.

Initially, and with reference to FIG. 4A, the social networking server 112 selects one or more keywords from a corpus of keywords (e.g., job titles 228) maintained by the social networking server 112 (Operation 404). As explained above, the job titles may be those that the social networking server 112 is configured to assign to one or more job postings (e.g., one or more job postings stored in the job posting database 122). Additionally, and/or alternatively, the social networking server 112 may identify those job titles to use as keywords by querying the job posting database 122 and extracting a job title (or job title identifier) from each of the job postings stored in the job posting database 122. In this manner, the social networking server 112 is configured to construct a list of job titles that are in use by members of the social networking service.

The social networking server 112 then queries one or more search engines using the identified job titles, where each job title is a query to each of the one or more search engines (Operation 406). In one embodiment, the social networking server 112 queries the one or more search engines using an API that exposes one or more services (anonymous, authenticated, etc.) for accessing one or more functions of the search engine. Additionally, and/or alternatively, the social networking server 112 may invoke a script or query written using a computer programming and/or scripting language, such as JavaScript, Perl, Python, or any other such language, to generate search queries, where the keyword for each generated search query is a job title selected from the job titles 228.

The social networking server 112 then identifies a predetermined number of search results for each query as being the most relevant search results (Operation 408). As discussed above, the predetermined number of search results may include the first five search results (e.g., the first five web pages), the first 10 search results (e.g. the first ten web pages), and so forth. Where the search results are returned as web pages, the social networking server 112 is configured to store the predetermined number of web pages as web page(s) 232.

The social networking server 112 may then execute or invoke a web page conversion module 212 to convert one or more of the web page(s) 232 to plain text documents (Operation 410). As explained above, and in one embodiment, converting the one or more of the web page(s) 232 to plain text documents may include removing one or more elements from the web page(s) 232 including, but not limited to, audiovisual content, syntactical language, text formatting, executable codes and/or scripts, and other such elements or combinations of elements. The web page conversion module 212 performs the conversion of the web page(s) 232 for each set of web page(s) associated with each keyword.

Referring to FIG. 4B, the social networking server 112 then generates a TF-IDF matrix of words appearing in the plain text webpages (Operation 412). As explained above with reference to FIG. 2, the generated TF-IDF matrix is stored as the TF-IDF matrices 234. The relevant term matrix generator 220 is configured to determine relevant n-grams from the TF-IDF matrices 234 for their corresponding keywords (e.g., job titles 228). In this regard, the relevant term matrix generator 220 may compare a predetermined threshold value with one or more of the values from the TF-IDF matrices 234. Where a given value from one or more of the TF-IDF matrices 234 exceeds the predetermined threshold value (Operation 414), the relevant term matrix generator 220 may then associate the n-gram associated with the given value with the corresponding keyword (e.g., job title) associated with the TF-IDF matrix from which the n-gram originates (Operation 416). In this manner, the relevant term matrix generator 220 constructs one or more database tables and/or other logical construct in which a given job title is associated with one or more terms that have been determined as being the most relevant from the converted webpages.

The social networking server 112 then determines whether there are remaining keywords (e.g., job titles 228) to process (Operation 418). If this determination is made in the affirmative (e.g., the “YES” branch of Operation 418), the method 402 then returns to Operation 404, where the social networking server 112 then selects another job title from the job titles 228 to process. If this determination is made in the negative (e.g., the “NO” branch of Operation 418), the relevant term matrix generator 220 then stores the matrix (e.g., database table, two-dimensional logical construct of job titles and relevant terms, etc.) as the key word associations 236 (operation 420).

FIGS. 5A-5B illustrate a method 502, in accordance with an example embodiment, for generating a second matrix of job titles and associated relevant terms, where the associated relevant terms were obtained from a second source. The method 502 may be implemented by one or more of the components and/or modules illustrated in FIG. 2, and is discussed by way of reference there to. In one embodiment, the method 502 corresponds to Operation 306 illustrated in FIG. 3A.

Initially, and with reference to FIG. 5A, the social networking server 112 selects one or more keywords from a corpus of keywords (e.g., job titles 228) maintained by the social networking server 112 (Operation 504). Thereafter, and for each job title selected from the plurality of job titles 228, the job posting identification module 214 identifies those job postings from the job posting database 122 that are associated with a given job title. These job postings are then stored as, or referenced as, the job postings 230 (Operation 506).

Using the job posting vectorization module 216, the social networking server 112 then vectorizes the contents of one or more of the job postings 230 using a job title selected from the job titles 228 (Operation 508). As discussed above, job posting vectorization module 216 is configured to vectorize one or more of the job postings 230 to obtain potentially relevant words and/or phrases that may be related to one or more of the job titles 228. Referring to FIG. 5B, after the one or more job postings 230 are vectorized, the social networking server 112 then generates another matrix of relevant terms to associated with a selected job title (Operation 510). As explained above, to obtain the relevant terms from the vectorized job postings, the job posting vectorization module 216 may cull or eliminate those words and/or phrases having a word cosine distance less than (or equal to) a predetermined word cosine distance value. The result of these operations are another set of words and/or phrases associated with each of the job titles 228, derived from the job postings 230, where each word and/or phrase is presumably related to a given job title. These associations may also be stored as part of the keyword associations 236.

The social networking server 112 then determines whether there are any remaining job titles 228 to associate with terms obtained from the vectorized job postings (Operation 512). In one embodiment, the social networking server 112 performs Operations 504-510 for each job title in the corpus of job titles 228. Where the social networking server 112 determines that there are remaining job titles to process (e.g., the “YES” branch of Operation 512), the method 502 returns to Operation 504. Otherwise, where the social networking server 112 determines that there are no remaining job titles to process (e.g., the “NO” branch of Operation 512), the method 502 proceeds to Operation 514. At Operation 514, the social networking server 112 then stores associations of the relevant terms (derived from the vectorized job postings 230) with each job title of the job titles 228. As explained above, these associations may be stored as keyword associations 236.

Referring back to FIG. 3A, the social networking server 112 then generates a third TF-IDF matrix from another set of search results (e.g., web pages) (Operation 308). In one embodiment, the search results are obtained from one or more search engines (or other provider of search results). As discussed above, the social networking server 112 may define a range of search results from this additional search that are considered sufficient in this determination. As before, the social networking server 112 may invoke the web page conversion module 212 to convert the second set of search results to plain text results (e.g., search results without additional syntactical or markup language), with the TF-IDF matrix generator 218 to generate one or more TF-IDF matrices from this additional set of search results, and a relevant term matrix generator 220 to generate a set of related terms.

The social networking server 112 then determines a first plurality of relevancy values for each of the job titles 228 using the keyword associations 236 obtained from the most relevant search results (e.g., the first set of search results) and the relevant terms from the additional set(s) of search results (Operation 310). As discussed with reference to FIG. 2, the relevancy determination module 222 implements one or more algorithms to determine the sets of relevancy values for each of the job titles 228. The relevancy determination module 222 may implement such algorithms as the Jaccard Index, the Euclidean Distance, the Pearson Correlation, Cosine Similarity, or any other such algorithm or combination thereof. Referring to FIG. 3B, the relevancy determination module 222 then determines a second plurality of relevancy values for each of the job titles 228 using the keyword associations 236 obtained from the vectorized job postings 230 and the relevant terms obtained from the additional set(s) of search results (Operation 312).

Using the determined relevancy values, the social networking server 112 then applies one or more regression models to determine the potential impact a change in the relevancy of the terms used by a given job posting may have on its ranking relative to a given search engine (Operation 314). As explained with reference to FIG. 2, the coefficient determination module 224 is configured to apply a regression model 240 to determine the regression model coefficients. The social networking server 112 then invokes the job posting relevancy identifier 226 to identify those job postings selected from the job postings 230 that would most likely experience a notable increase in a search engine ranking from changes that improve the relevancy of the words and phrases used by the job posting (Operation 316). In one embodiment, the social networking server 112 communicates a notification to each member associated with the identified job postings from Operation 316 via a webpage, electronic message (e.g., e-mail), or other such communication.

In this manner, the disclosed systems and methods provide a solution to search engine optimization for job postings provided by and/or accessible from a social networking service. As search engines have become the predominant mechanism that Internet users use to discover content, a better ranked search result can increase the number of Internet users that select, and ultimately view, the better ranked search result. In the context of a social networking service, where the job postings are returned as search results to a search query, a better ranked job posting can lead to potential new job candidates or job candidates that are more likely matches for the job associated with the job posting.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a FPGA or an ASIC. A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 2-5B are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things” while yet another combination produces a server computer for use within a cloud computing architecture. Not all combinations of such software and hardware architectures are presented here as those of skill in the art can readily understand how to implement the inventive subject matter in different contexts from the disclosure contained herein.

### Example Machine Architecture and Machine-Readable Medium

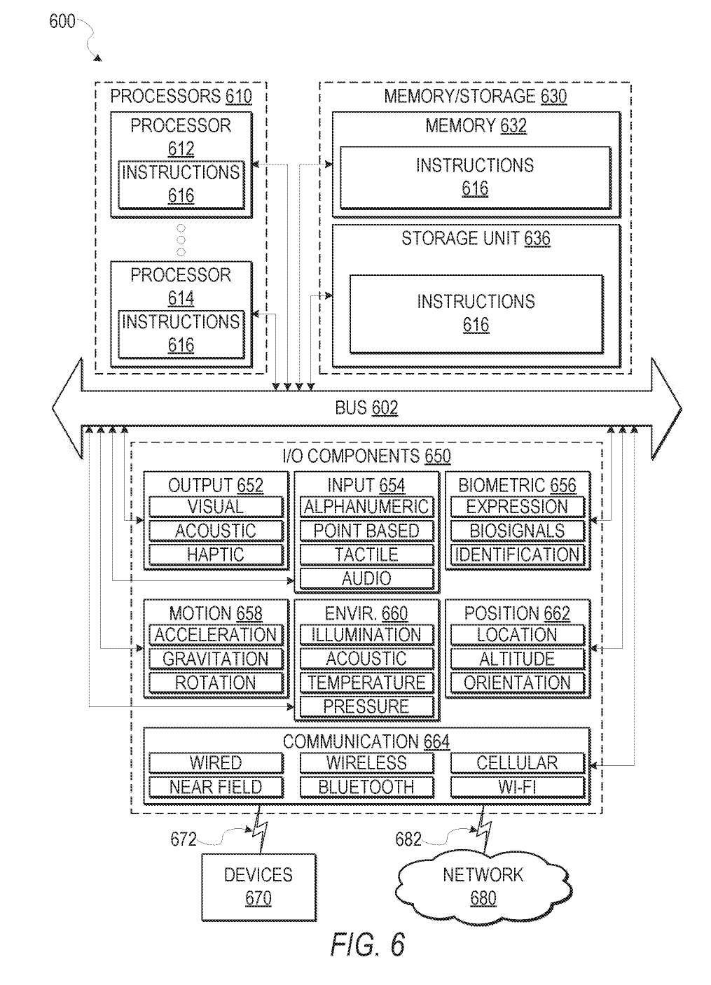

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example, the instructions 616 may cause the machine 600 to execute the flow diagrams of FIGS. 3A-5B. Additionally, or alternatively, the instructions 616 may implement one or more of the components of FIG. 2. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a PDA, or any machine capable of executing the instructions 616, sequentially or otherwise, that specify actions to be taken by machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory/storage 630, and I/O components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, processor 612 and processor 614 that may execute the instructions 616. The term “processor” is intended to include multi-core processor that may comprise two or more independent processors (sometimes referred to as “cores”) that may execute instructions 616 contemporaneously. Although FIG. 6 shows multiple processors 610, the machine 600 may include a single processor with a single core, a single processor with multiple cores (e.g., a multi-core process), multiple processors with a single core, multiple processors with multiples cores, or any combination thereof.

The memory/storage 630 may include a memory 632, such as a main memory, or other memory storage, and a storage unit 636, both accessible to the processors 610 such as via the bus 602. The storage unit 636 and memory 632 store the instructions 616 embodying any one or more of the methodologies or functions described herein. The instructions 616 may also reside, completely or partially, within the memory 632, within the storage unit 636, within at least one of the processors 610 (e.g., within the processor's cache memory), or any suitable combination thereof, during execution thereof by the machine 600. Accordingly, the memory 632, the storage unit 636, and the memory of processors 610 are examples of machine-readable media.

As used herein, “machine-readable medium” means a device able to store instructions 616 and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 616. The term “machine-readable medium” shall also be taken to include any medium, or combination of multiple media, that is capable of storing instructions (e.g., instructions 616) for execution by a machine (e.g., machine 600), such that the instructions, when executed by one or more processors of the machine 600 (e.g., processors 610), cause the machine 600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662 among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 662 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via coupling 682 and coupling 672, respectively. For example, the communication components 664 may include a network interface component or other suitable device to interface with the network 680. In further examples, communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a USB).

Moreover, the communication components 664 may detect identifiers or include components operable to detect identifiers. For example, the communication components 664 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF416, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 680 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 680 or a portion of the network 680 may include a wireless or cellular network and the coupling 682 may be a Code Division Multiple Access (CDMA) connection, a Global System for Mobile communications (GSM) connection, or other type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., hypertext transfer protocol (HTTP)). Similarly, the instructions 616 may be transmitted or received using a transmission medium via the coupling 672 (e.g., a peer-to-peer coupling) to devices 670. The term “transmission medium” shall be taken to include any intangible medium that is capable of storing, encoding, or carrying instructions 616 for execution by the machine 600, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a machine-readable medium storing computer-executable instructions; and
at least one hardware processor communicatively coupled to the machine-readable medium that, when the computer-executable instructions are executed, configures the system to:
obtain a first plurality of search results from a first source using a plurality of keywords;
obtain a second plurality of search results from a second source using the plurality of keywords;
obtain a third plurality of search results from the first source using the plurality of keywords;
determine a first plurality of relevancy values for each keyword of the plurality of keywords based on the first plurality of search results and the third plurality of search results;
determine a second plurality of relevancy values for each keyword of the plurality of keywords based on the second plurality of search results and the third plurality of search results
determine at least one coefficient of a regression model based on the determined first plurality of relevancy values and the determined second plurality of relevancy values;
identify a plurality of job postings associated with corresponding keywords of the plurality of keywords based on the determined at least one coefficient; and
communicate the identification of at least one job posting selected from the identified plurality of job postings.

2. The system of claim 1, wherein:
the first source comprises a search engine, and the first plurality of search results comprises webpages indexed by the first source; and
the second source comprises a social networking service, and the second plurality of search results comprises job postings maintained by the social networking service.

3. The system of claim 1, wherein the first plurality of search results comprises a first predetermined number of search results, at least one search result having a rank greater than a predetermined rank.

4. The system of claim 3, wherein the third plurality of search results comprises a second predetermined number of search results, at least one search result having a rank less than the predetermined rank.

5. The system of claim 1, wherein the system is further configured to perform a plain text conversion of at least one search result selected from the second plurality of search results, the plain text conversion comprising removing syntactic language from the at least one search result.

6. The system of claim 1, wherein the system is further configured to vectorize at least one search result selected from the second plurality of search results.

7. The system of claim 1, wherein the system is configured to determine the first plurality of relevancy values for each keyword of the plurality of keywords by:
vectorizing the first plurality of search results and determining a first plurality of terms from the first plurality of search results that are related to a given keyword;
vectorizing the third plurality of search results and determining a second plurality of terms from the third plurality of search results that are related to the given keyword; and
determining a Jaccard Index using the given keyword, the first plurality of terms, and the second plurality of terms, wherein the Jaccard Index represents the relevancy value corresponding to the given keyword.

8. A method comprising:
obtaining, with one or more hardware processors, a first plurality of search results from a first source using a plurality of keywords;
obtaining, with the one or more hardware processors, a second plurality of search results from a second source using the plurality of keywords;
obtaining, with the one or more hardware processors, a third plurality of search results from the first source using the plurality of keywords;
determining, with the one or more hardware processors, a first plurality of relevancy values for each keyword of the plurality of keywords based on the first plurality of search results and the third plurality of search results;
determining, with the one or more hardware processors, a second plurality of relevancy values for each keyword of the plurality of keywords based on the second plurality of search results and the third plurality of search results;
determining, with the one or more hardware processors, at least one coefficient of a regression model based on the determined first plurality of relevancy values and the determined second plurality of relevancy values;
identifying, with the one or more hardware processors, a plurality of job postings associated with corresponding keywords of the plurality of keywords based on the determined at least one coefficient; and
communicating the identification of at least one job posting selected from the identified plurality of job postings.

9. The method of claim 8, wherein:
the first source comprises a search engine, and the first plurality of search results comprises webpages indexed by the first source; and
the second source comprises a social networking service, and the second plurality of search results comprises job postings maintained by the social networking service.

10. The method of claim 8, wherein the first plurality of search results comprises a first predetermined number of search results, at least one search result having a rank greater than a predetermined rank.

11. The method of claim 10, wherein the third plurality of search results comprises a second predetermined number of search results, at least one search result having a rank less than the predetermined rank.

12. The method of claim 8, further comprising:
performing a plain text conversion of at least one search result selected from the second plurality of search results, the plain text conversion comprising removing syntactic language from the at least one search result.

13. The method of claim 8, further comprising:
vectorising at least one search result selected from the second plurality of search results.

14. The method of claim 8, wherein determining the first plurality of relevancy values for each keyword of the plurality of keywords comprises:
vectorising the first plurality of search results and determining a first plurality of terms from the first plurality of search results that are related to a given keyword;
vectorising the third plurality of search results and determining a second plurality of terms from the third plurality of search results that are related to the given keyword; and
determining a Jaccard Index using the given keyword, the first plurality of terms, and the second plurality of terms, wherein the Jaccard Index represents the relevancy value corresponding to the given keyword.

15. A computer-readable medium storing computer-executable instructions that, when executed by one or more hardware processors, cause the one or more hardware processors to perform a plurality of operations, the plurality of operations comprising:
obtaining a first plurality of search results from a first source using a plurality of keywords;
obtaining a second plurality of search results from a second source using the plurality of keywords;
obtaining a third plurality of search results from the first source using the plurality of keywords;
determining a first plurality of relevancy values for each keyword of the plurality of keywords based on the first plurality of search results and the third plurality of search results;
determining a second plurality of relevancy values for each keyword of the plurality of keywords based on the second plurality of search results and the third plurality of search results;
determining at least one coefficient of a regression model based on the determined first plurality of relevancy values and the determined second plurality of relevancy values;
identifying a plurality of job postings associated with corresponding keywords of the plurality of keywords based on the determined at least one coefficient; and
communicating the identification of at least one job posting selected from the identified plurality of job postings.

16. The computer-readable medium of claim 15, wherein:
the first source comprises a search engine, and the first plurality of search results comprises webpages indexed by the first source; and
the second source comprises a social networking service, and the second plurality of search results comprises job postings maintained by the social networking service.

17. The computer-readable medium of claim 15, wherein the first plurality of search results comprises a first predetermined number of search results, at least one search result having a rank greater than a predetermined rank.

18. The computer-readable medium of claim 17, wherein the third plurality of search results comprises a second predetermined number of search results, at least one search result having a rank less than the predetermined rank.

19. The computer-readable medium of claim 15, wherein the plurality of operations further comprise:
performing a plain text conversion of at least one search result selected from the second plurality of search results, the plain text conversion comprising removing syntactic language from the at least one search result.

20. The computer-readable medium of claim 15, wherein determining the first plurality of relevancy values for each keyword of the plurality of keywords comprises:
vectorizing the first plurality of search results and determining a first plurality of terms from the first plurality of search results that are related to a given keyword;
vectorizing the third plurality of search results and determining a second plurality of terms from the third plurality of search results that are related to the given keyword; and
determining a Jaccard Index using the given keyword, the first plurality of terms, and the second plurality of terms, wherein the Jaccard Index represents the relevancy value corresponding to the given keyword.
